(19) United States
(12) Patent Application Publication
(10) Pub. No.: US 2026/0250027 A1
(43) Pub. Date: Aug. 27, 2026

(54) METHOD AND SYSTEM FOR PROVIDING OPHTHALMIC LENSES IN LENS RECEPTACLES

(71) Applicant: Alcon Inc., Fribourg (CH)

(72) Inventors: Roger Biel, Aschaffenburg (DE); Felix Brinckmann, Roßdorf (DE); Marcus Heift, Großostheim (DE); Nils Schweizer, Bad König (DE)

(21) Appl. No.: 19/549,221

(22) Filed: Feb. 25, 2026

Related U.S. Application Data
(60) Provisional application No. 63/763,610, filed on Feb. 26, 2025.

(51) Int. Cl. B65B 57/14; B65B 25/00

(52) U.S. Cl. CPC B65B 57/14; B65B 25/008

(57) ABSTRACT

An inspection glass holder is suggested for carrying a plurality of inspection glasses. The holder comprises a QR code that is commonly allocated to the inspection glasses arranged thereon. Prior to separating the foil from the blister, the data printed on the foil including the individual blister code is automatically read and is allocated to the QR code of the holder in the same sequence. Thereafter, the foil is separated from the shells and the lenses are transferred from the shells of the blister packages to the inspection glasses in the same sequence. The parameters of the lenses measured in the inspection glasses are correctly associated to the data read from the foil which are all allocated to the same QR code of the holder.

### FIELD OF THE INVENTION

The present invention generally relates to the field of manufacturing of ophthalmic lenses, in particular contact lenses such as soft contact lenses. More particularly, the invention relates to a method and a system for providing a predetermined number of ophthalmic lenses manufactured in an automated lens manufacturing process in a plurality of lens receptacles.

### BACKGROUND

In the field of manufacturing ophthalmic lenses, in particular contact lenses such as soft contact lenses, large numbers of lenses are produced in an automated lens manufacturing process in an automated lens manufacturing line. Typically, a number of routine lens inspections are performed to make sure all of the strict quality criteria are met by each lens manufactured in the automated lens manufacturing process.

Once the lenses have successfully passed inspection, they are transferred to primary packages, one lens into one primary package. The primary packaging shell may further contain a storage solution (e.g. saline). Each primary package is sealed by a sealing foil sealing the respective primary package shell.

Typically, strips of primary packages are produced in the automated lens manufacturing process. Such a strip of primary packages is typically formed by a predetermined number of individual primary packages, for example three or five such primary packages (any other number being possible as well) arranged adjacently to one another in a row.

A machine-readable unique lens identifier is assigned to each lens and is applied (e.g. printed) to the sealing foil such that each primary package comprises a unique lens identifier identifying the lens supposed to be contained therein. As a large number of machine data used in the lens manufacturing line are stored in a manner allocated to each individual lens produced, it is possible to allocate each unique lens identifier to machine data and to store the machine data used in the manufacture of each individual lens to which the respective unique individual lens identifier is allocated in a data storage.

A statistical process control (SPC) is performed to monitor the smooth operation of the lens manufacturing process of the automated lens manufacturing line. The SPC comprises the drawing of samples from the automated lens manufacturing line after certain time intervals, each sample consisting of a predetermined number of sample strips. The lenses contained in the primary packages of the sample strips are taken out of the primary packaging shells after the sealing foil has been removed from the respective primary packaging shell, and are inspected as to whether the lenses - which have successfully passed the inspection in the manufacturing line - indeed fulfil the strict quality criteria.

An exemplary number of lenses to be inspected in the SPC within one sample drawn from the production line may be twenty lenses, although any other representative number of lenses within one sample is possible as well. To make sure one sample always contains twenty lenses, five sample strips (each containing five primary packages) may be drawn from the lens manufacturing line in one sample. This is because even though a lens presence check for one lens in one primary package is typically performed in the primary packaging module of the automated lens manufacturing line, it may occur that an individual primary package of a strip contains either no lens, or contains more than one lens. In the latter case, the lenses may not be used for the SPC, since no clear allocation of the manufacturing data to any of the two or more lenses is possible.

In the normal case (one lens contained in each primary package of a sample strip), the lens contained in the first primary package of a sample strip is picked from the primary packaging shell of the first primary package and placed into a first lens receptacle arranged on a lens receptacle carrier on which five lens receptacles are arranged in total. The sealing foil of the first primary package of the sample strip is attached (e.g. glued or taped) to the first lens receptacle arranged on the lens receptacle carrier. Thereafter, a lens of the second primary package of the same sample strip is placed in the second lens receptacle arranged on the lens carrier, however, due to the laborious and cumbersome process of attaching the foil to the lens receptacle the foil of the second primary package is not attached to the second lens receptacle arranged on the lens receptacle carrier. The latter procedure is repeated for each lens contained in each primary package of the same sample strip as long as each primary package of the sample strip contains one lens, so that in the normal case the five lenses contained in the five primary packages of the same sample strip are finally arranged in the five lens receptacles arranged on the lens receptacle carrier in the same sequence in which they were arranged in the primary packages of the sample strip. Due to the process of attaching the foil to the lens receptacle being laborious and cumbersome, the foils of the other four primary packages of the sample strip are not attached to the corresponding lens receptacles arranged on the lens receptacle carrier.

In case one or more of the second, third, fourth or fifth primary packages of a sample strip contains either no lens or contains two lenses, a problem arises. For example, let us assume two lenses are contained in the third primary packaging shell of a sample strip comprising five primary packages in total. The lenses contained in the first and second primary packaging shells of the sample strip are transferred to the first and second lens receptacles arranged on the lens receptacle carrier. However, none of the two lenses contained in the third primary packaging shell of the sample strip is placed into the third lens receptacle arranged on the lens receptacle carrier. Rather, the lens contained in the fourth primary package of the sample strip is placed into the third receptacle arranged on the lens receptacle carrier, and the lens contained in the fifth primary package of the sample strip is placed into the fourth lens receptacle on the lens receptacle carrier. The fifth lens receptacle arranged on the lens receptacle carrier is then filled with the lens of the first primary package of the next (i.e. second) sample strip, and the foil of this first primary package is attached to the fifth lens receptacle indicating that the lens contained in the fifth lens receptacle is from the next (i.e. second) sample strip. Assuming that in the next (i.e. second) sample strip each primary package contains one lens, the first, second, third and fourth lens receptacle on the next (i.e. second) lens receptacle carrier are filled with the lenses contained in the second, third, fourth and fifth primary package of the sample strip of which the foil of the first primary package has been attached to the fifth lens receptacle arranged on the preceding (i.e. first) lens receptacle carrier. This process is repeated until the twenty lens receptacles arranged on the four lens receptacle carriers are each filled with one lens (since the sample as a whole contains twenty lenses).

Turning back to the first lens receptacle carrier, while it is clear that the lens contained in the first lens receptacle is that of the first primary package of the (first) sample strip (indicated by the foil attached to the first lens receptacle), for the lenses contained in the second, third and fourth lens receptacle it is not clear from which primary package of the (first) sample strip they have been taken so that for these lenses it is not possible to allocate their manufacturing data. This problem occurs each time no lens is present in one or more primary packages of a sample strip, and each time two (or more) lenses are contained in one or more primary packages of a sample strip.

In case in the SPC a predetermined number of deviations from the strict quality criteria is detected, suitable measures must be taken which - in a worst-case scenario - may lead to destruction of the whole lot of lenses produced by the manufacturing line. These lenses may not be distributed since customer complaints are completely unwanted and must be avoided. Obviously, this has a negative effect on the production yield. And in case there are a number of occurrences in which the manufacturing data cannot be allocated to the lenses contained in the lens receptacles on the lens receptacle carriers (see discussion above), it may not be possible to determine possible reasons (in the manufacturing line) for the lenses produced by the lens manufacturing line not meeting the strict quality criteria.

### SUMMARY OF THE INVENTION

In accordance with the present invention, a method and a system for providing a predetermined number of ophthalmic lenses are suggested, as it is specified by the features of the independent claims. Advantageous aspects of the method and the system are the subject of the respective dependent claims.

As used in the specification including the appended claims, the singular forms "a", "an", and "the" include the plural, unless the context explicitly dictates otherwise. When using the term "about" with reference to a particular numerical value or a range of values, this is to be understood in the sense that the particular numerical value referred to in connection with the term "about" is included and explicitly disclosed, unless the context clearly dictates otherwise. For example, if a range of "about" numerical value A to "about" numerical value B is disclosed, this is to be understood to include and explicitly disclose a range of numerical value A to numerical value B. Also, whenever features are combined with the term "or", the term "or" is to be understood to also include "and" unless it is evident from the specification that the term "or" must be understood as being exclusive.

According to the invention, a method for providing a predetermined number of ophthalmic lenses, in particular contact lenses such as soft contact lenses, manufactured in an automated lens manufacturing process in a plurality of lens receptacles arranged on one or more lens receptacle carriers, is suggested. The method comprises the steps of:
drawing a first number of primary packages, each supposed to contain one ophthalmic lens of a same lot of ophthalmic lenses manufactured in the automated lens manufacturing process, and each comprising a machine-readable unique lens identifier allocated to manufacturing data of the ophthalmic lens supposed to be contained therein,
selecting from the first number of primary packages a second number of primary packages as sample primary packages, each sample primary package actually containing one ophthalmic lens, the second number of primary packages corresponding to the predetermined number of ophthalmic lenses to be provided,
reading the machine-readable unique lens identifier of each sample primary package,
reading a machine-readable unique carrier identifier of each of the one or more lens receptacle carriers,
transferring each ophthalmic lens from the respective sample primary package to a different lens receptacle of the plurality of lens receptacles arranged at a respective receptacle location on the one or more lens receptacle carriers,
for each transferred ophthalmic lens, assigning the unique lens identifier and the receptacle location on the lens receptacle carrier to the unique carrier identifier of the one or more lens receptacle carriers, and storing said assignment.

According to one aspect of the method according to the invention, each primary package is sealed by a sealing foil, and the machine-readable unique lens identifier allocated to the manufacturing data for the ophthalmic lens supposed to be contained therein is applied to the sealing foil.

The method further comprises the steps of
removing the sealing foil from each primary package, and
arranging the sealing foil of each sample primary package on the lens receptacle carrier at a location that is assigned to the respective different lens receptacle to which the respective ophthalmic lens has been transferred, with the respective machine-readable unique lens identifier being exposed for reading.

According to another aspect of the method according to the invention, subsequent to the step of arranging the sealing foil of each sample primary package on the lens receptacle carrier the method further comprises the steps of:
re-reading the unique carrier identifier of each of the one or more lens receptacle carriers,
re-reading the unique lens identifier of each sealing foil arranged on the lens receptacle carrier at the respective location that is assigned to the respective different lens receptacle,
retrieving for each unique carrier identifier the stored assignment of the unique lens identifiers and the receptacle locations to the said unique carrier identifier,
for each lens receptacle carrier and its unique carrier identifier determining whether
the re-read unique lens identifiers and the locations at which the sealing foils are arranged on the respective lens receptacle carrier
match with
the unique lens identifiers and the receptacle locations on the respective lens receptacle carrier of the stored assignment.

According to yet another aspect of the method according to the invention, the step of selecting from the first number of primary packages a second number of primary packages as sample primary packages further comprises
successively opening the primary packages of the first number of primary packages and determining the number of ophthalmic lenses contained in each primary package, and thereafter
selecting the respective primary package as sample primary package in case the determined number of lenses contained in the respective primary package is one,
rejecting the respective primary package in case the determined number of ophthalmic lenses contained in the respective primary package is different from one.

The step of reading the machine-readable unique lens identifier of each sample primary package comprises reading the machine-readable unique lens identifier of all primary packages of the first number of primary packages.

In case at least one primary package of the first number of primary packages is rejected, a rejection flag is assigned to the unique lens identifier of each rejected primary package, and said assignment is stored.

According to a further aspect of the method according to the invention,

the primary packages are separably connected to one another to form strips of primary packages, each strip comprising a predetermined number of primary packages,

wherein each lens receptacle carrier of the one or more lens receptacle carriers comprises a predetermined number of lens receptacles arranged thereon corresponding to the predetermined number of primary packages of a said strip.

The step of drawing the first number of primary packages comprises drawing a number of strips of primary packages larger than the number of lens receptacle carriers.

In case each primary package of a said strip of primary packages is a sample primary package containing one ophthalmic lens, the ophthalmic lens is transferred from the respective sample primary package into the respective different one of the lens receptacles arranged on a said lens receptacle carrier of the one or more lens receptacle carriers.

In case a primary package of a said strip of primary packages contains a number of ophthalmic lenses different from one, only those ophthalmic lenses from the sample primary packages of the said strip are transferred to the respective different ones of the lens receptacles of a said lens receptacle carrier of the one or more lens receptacle carriers, and an ophthalmic lens from a sample primary package of another said strip of the drawn number of strips is transferred to the remaining lens receptacle of the said lens receptacle carrier of the one or more lens receptacle carriers, such that each lens receptacle of the said lens receptacle carrier of the one or more lens receptacle carriers contains one ophthalmic lens.

According to another aspect of the method according to the invention, the predetermined number of primary packages separably connected to one another to form a strip of primary packages is five, and the number of lens receptacle carriers is four.

According to yet another aspect of the method according to the invention, the predetermined number of ophthalmic lenses is twenty.

According to a further aspect of the method according to invention, the step of reading the machine-readable unique lens identifier comprises reading at least one of a machine-readable text, a quick-response code (QR-code), a machine-readable number, and a bar code, comprising the unique lens-identifier.

According to the invention, also a system is suggested for providing a predetermined number of ophthalmic lenses, in particular contact lenses such as soft contact lenses, in a plurality of lens receptacles, one ophthalmic lens in each lens receptacle of the plurality of lens receptacles, each ophthalmic lens being manufactured in a same lot in an automated lens manufacturing process and being transferred from a primary package containing the ophthalmic lens, the primary package comprising a machine-readable unique lens identifier allocated to manufacturing data for the ophthalmic lens contained therein.

The system comprises:
one or more said lens receptacle carriers, each comprising
a machine-readable unique carrier identifier, and
a plurality of receptacle holders, each receptacle holder being configured to hold one said lens receptacle, and being located at a different holder location on the one or more lens receptacle carriers,
and
a data storage configured for storing an assignment of the unique lens identifier and the receptacle holder location on the lens receptacle carrier to the unique carrier identifier of the one or more lens receptacle carriers.

According to one aspect of the system according to the invention,

each primary package is sealed by a sealing foil, wherein the machine-readable unique lens identifier allocated to the manufacturing data for the ophthalmic lens contained therein is applied to the sealing foil,

and each lens receptacle carrier comprises a number of foil holders corresponding to the number of receptacle holders, each for holding the sealing foil of one primary package.

Each foil holder is arranged at a location assigned to the respective receptacle holder.

According to another aspect of the system according to invention,

each of the foil holders comprises a foil holder clip partly arranged underneath the respective receptacle holder.

The foil holder clip comprises a tray portion for receiving the respective sealing foil to be arranged thereon such that the respective machine-readable unique lens identifier is exposed for reading.

According to another aspect of the system according to the invention,

the primary packages are separably connected to form strips of primary packages, each strip formed by a predetermined number of primary packages.

The number of receptacle holders of each of the one or more lens receptacle carriers corresponds to the number of primary packages of the respective strip of primary packages.

According to yet another aspect of the system according to the invention, a said strip of primary packages is formed by five primary packages, and each lens receptacle carrier comprises five lens receptacle holders and the one or more lens receptacle carriers comprise four lens receptacle carriers.

According to a further aspect of the system according to the invention, the machine-readable unique carrier identifier is comprised by at least one selected from the group of a quick-response code (QR-code), a machine-readable text, a machine-readable number, a transponder, and a barcode.

The method according to the invention is advantageous in that for each ophthalmic lens transferred to a respective lens receptacle arranged on the one or more lens receptacle carriers, the unique lens identifier as well as the receptacle location of the respective lens receptacle (to which the lens has been transferred) on the lens receptacle carrier are explicitly assigned to the unique carrier identifier of the respective lens receptacle carrier. As a consequence, by simply reading the machine-readable unique carrier identifier from a lens receptacle carrier (for example in the Statistical Process Control SPC) it is clear which lens is contained in which lens receptacle on the lens receptacle carrier, and the manufacturing data stored for that lens can then be easily retrieved. For example, in case a predetermined number of deviations from the strict quality criteria is detected (e.g. during inspection of the ophthalmic lenses in the SPC), possible reasons for the deviation from the strict quality criteria may be determined. And there may be numerous reasons for deviations from the strict quality criteria, such as a defective component of the manufacturing line, for instance a defective injection nozzle for the lens-forming material which may thus be detected and tracked. In case such reason for the deviation from the strict quality criteria is detected to occur to an extent that corrective action is required, it may be sufficient to discard only those primary packages in which an ophthalmic lens is contained that has been manufactured by the defective component of the manufacturing line. Previously, in such instances the whole lot of ophthalmic lenses has been discarded in order to avoid the distribution of too large a number of ophthalmic lenses which are not compliant with the strict quality criteria.

The first number of primary packages are drawn from the production of a same lot of ophthalmic lenses. A same lot of ophthalmic lenses denotes a plurality of ophthalmic lenses all having the same specifications and all being produced in the same manufacturing run.

By drawing a first (larger) number of primary packages and subsequently selecting therefrom a second (smaller) number of primary packages as sample primary packages (each sample primary package containing exactly one ophthalmic lens) the desired predetermined number of ophthalmic lenses may be provided even in case one or more primary packages of the first (larger) number of primary packages does not contain exactly one ophthalmic lens (ophthalmic lenses of such packages are not used).

The first number of primary packages may be drawn at several times during production of the same lot of ophthalmic lenses. Typically, the said first number of primary packages may be drawn at the start and at the end of the production of a same lot, as well as at certain times between the start and the end of production of the said lot. How often the first number of primary packages are actually drawn from the production of a same lot depends on the overall size of the respective lot (i.e. the total number of ophthalmic lenses of a same lot). It is noteworthy in this regard, that the number of times that the first number of primary packages is actually drawn from the production is typically higher (compared to the overall size of a same lot) for a smaller overall size of a same lot than for a larger overall size.

The predetermined number of ophthalmic lenses to be provided (after one draw of the first number of primary packages) may be any number suitable to perform a representative Statistical Process Control (SPC). For example (and without being limited thereto), a suitable predetermined number of ophthalmic lenses to be provided after one draw may be twenty ophthalmic lenses. Of course, the first number of the primary packages comprised by one draw must be larger than the predetermined number of ophthalmic lenses to be provided after one draw, and must therefore also be larger than the second number of primary packages which are selected as sample primary packages (only those primary packages containing exactly one ophthalmic lens are selected as sample primary packages). The first number of primary packages of one draw is determined in view of the predetermined number of ophthalmic lenses to be provided after one draw, and further in view of the maximum expected number of primary packages containing a number of ophthalmic lenses different from one (obviously, this maximum expected number is very low, as otherwise the production process is not efficient). For example, in case a predetermined number of primary packages is separably connected to form strips of primary packages, typically one additional strip of primary packages is drawn in addition to the number of strips that would be needed if each primary package actually contained exactly one ophthalmic lens. For instance, in case each strip is formed of five primary packages and the predetermined number of ophthalmic lenses to be provided after one draw is twenty, the first number of primary packages exceeds the predetermined number of ophthalmic lenses to be provided by five (as in such instance five strips are comprised by one draw).

Selecting from the first number of primary packages (in the afore-described example twenty-five primary packages, corresponding to five strips) a second number of primary packages (in the afore-described example twenty primary packages) as sample primary packages (each containing exactly one ophthalmic lens) may be performed either by visual inspection of the respective (open) primary package through an operator, or may be automatically performed with the aid of a machine vision system. More frankly speaking, this means that the check whether a primary package contains one ophthalmic lens or a number different from one is performed either by an operator or automatically.

Reading the machine-readable unique lens identifier from the sample primary package and reading the machine-readable unique carrier identifier from the lens receptacle carrier carrying that lens receptacle into which the ophthalmic lens is transferred from the sample primary package is performed automatically, and may be performed with a suitable electronic reading device, such as a laser scanner, a camera-based reader, or a suitable device for reading a transponder (e.g. in case the machine-readable unique carrier identifier is embodied as a transponder).

The unique lens identifier allocated to the manufacturing data of the respective ophthalmic lens is stored, for instance, in a database. In addition to all optical parameters (e.g. lens geometry, refractive power, etc.) and material parameters (e.g. type lens-forming material, batch of lens-forming material, coating, etc.) related to the ophthalmic lens itself, a huge number of further manufacturing parameters is typically comprised by the manufacturing data of each individual ophthalmic lens. Just to give a few examples, the dosing nozzle used to dose the lens-forming material into the lens mold, the transfer gripper used to transfer the ophthalmic lens from the inspection cuvette into the primary package, etc., may be stored. These are only very few examples of such manufacturing parameters. Actually, a huge number of additional manufacturing parameters are stored for each individual ophthalmic lens in a manner allocated to the unique lens identifier of that ophthalmic lens.

Once a primary package is open and it is determined that the primary package contains exactly one ophthalmic lens (i.e. the primary package qualifies as a sample primary package), the ophthalmic lens may be transferred from the respective sample primary package to the lens receptacle on the lens receptacle carrier either (manually) by an operator or by an automated gripper system.

The assignment of the unique lens identifier and the receptacle location on the lens receptacle carrier to the unique carrier identifier may be stored in a suitable data storage that allows for retrieval of the said assignment, for example at the time the ophthalmic lenses are inspected in the SPC. A suitable data storage may for instance be a memory unit of a computer or a server.

Typically, the unique lens identifier is applied to the sealing foil (e.g. by laser printing or any other suitable technique). The sealing foil may be arranged on the lens receptacle carrier at a location that is assigned to that lens receptacle to which the ophthalmic lens has been transferred. This allows to read the unique lens identifier and thus to identify the ophthalmic lens arranged in the lens receptacle to which the location of the respective sealing foil is assigned. And even though this information is redundant (since the unique lens identifier and the receptacle location are assigned to the unique carrier identifier), such arrangement of the foil may possibly serve as backup solution in case the stored assignment of the unique lens identifier and the receptacle location cannot be retrieved from the data storage for any reason, for instance due to technical problems such as a server problem. In addition, it allows to perform a double-check in case such double-check is desirable. Such double-check may be performed, for example, by re-reading the unique carrier identifier from the lens receptacle carrier, and then re-reading the unique lens identifier from the sealing foil arranged at the respective location assigned to the lens receptacle arranged on the carrier. Thereafter, this information may be compared with the stored assignment of the unique lens identifiers and the receptacle locations to the unique carrier identifier.

During opening of the primary packages, it may turn out that a primary package contains a number of ophthalmic lenses different from one (even though this occurs very rarely only). In such instance, the ophthalmic lenses (if any) contained in such primary package are not transferred to the lens receptacle (evidently, if no ophthalmic lens is contained it cannot be transferred either). In such instance, a rejection flag may be assigned to the unique lens identifier of that primary package, and this assignment of the rejection flag to the unique lens identifier may be stored, too. This may be advantageous in that it allows for determining possible reasons for such occurrences. For example, in case one of the transfer grippers transferring ophthalmic lenses from the inspection cuvettes to the primary package is defective, such scenarios may occur more than once. From the manufacturing data allocated to the unique lens identifiers, the defective transfer gripper may then be identified.

All primary packages of an individual strip of primary packages contain the same type of lens (they are from the same lot). Typical numbers of primary packages forming a strip are three or five, even though other numbers are possible. The primary packages of a strip may be separably connected by the foil strip which is sealed to the individual primary packaging shells to form a said strip.

In one embodiment, each strip of primary packages comprises five primary packages, and the number of lens receptacle carriers for each draw of sample primary packages is four (with each lens receptacle carrier having five lens receptacles arranged thereon). This means, that the total number of ophthalmic lenses to be transferred into the lens receptacles for each draw is twenty. This number of twenty is a representative number for each draw in a Statistical Process Control (SPC).

With respect to the lens receptacle carrier, the machine-readable unique carrier identifier may be arranged such that it is exposed for automatic reading. The holder locations for holding the lens receptacles may be arranged next to each other in a row such that once the lens receptacles are arranged on the carrier they are arranged on the carrier along the said row.

The lens receptacles may be cylindrically shaped receptacles and may be made of glass or a suitable transparent plastic material. Each of the lens receptacles may further comprise a lid for closing the lens receptacle. All lens receptacles may be filled with liquid, such as water or saline, prior to the transfer of the ophthalmic lens from the sample primary package to the lens receptacle.

Each of the receptacle holders may be configured for removably holding the respective lens receptacle on the lens receptacle carrier. For example, a receptacle holder may be embodied as a cylindrical recess matching the cylindrical outer shape of the respective cylindrically shaped lens receptacle.

The number of foil holders of a said lens receptacle carrier corresponds to the number of receptacle holders, so that for each lens transferred from a sample primary package to a lens receptacle the corresponding foil can also be held by the lens receptacle carrier for the reasons already discussed above. The location of each foil holder may be spatially assigned to the receptacle holder. For instance, each foil holder may be arranged at a location which is closest to the corresponding receptacle holder to which it is assigned. For example, the respective foil holder may be arranged partly underneath the respective receptacle holder.

The foil holder may comprise a foil holder clip so that the respective sealing foil may be removably clamped by the respective foil holder clip at the respective location without any adhesive.

The foil holder may comprise a tray portion that serves to support the bottom surface of the sealing foil, whereas the top surface of the sealing foil may be exposed at least partially such that the portion that comprising the unique lens identifier is exposed for reading.

In an embodiment of the lens receptacle carrier, the number of receptacle holders corresponds to the predetermined number of primary packages of a said strip of primary packages. This is advantageous since in the vast majority of cases each primary package of a said strip contains exactly one ophthalmic lens, so that normally all ophthalmic lenses of the same strip are transferred one-by-one into the lens receptacles of the same lens receptacle carrier.

By way of example, the unique carrier identifier may comprise at least one selected from the group of machine-readable text, a machine-readable number, a quick-response code (QR-code), and a bar code. Such machine-readable codes allow for fast digital processing and storage of the unique carrier identifier. Even though only one of the afore-mentioned machine-readable text, machine-readable number, quick-response code (QR-code), and the bar code may be present on the lens receptacle carrier, combinations thereof are possible as well. Similar types of code may be used for the unique lens identifier applied to the sealing foil.

### BRIEF DESCRIPTION OF THE DRAWINGS

Further advantageous aspects of the invention become apparent from the following description of embodiments of the invention with the aid of the (schematic) drawings, in which:

FIG. 1 shows a perspective view of a lens receptacle carrier of an embodiment of the system according to the invention, with lens receptacles arranged thereon and with sealing foils of sample primary packages clamped thereto;

FIG. 2 shows a top view of the lens receptacle carrier of FIG. 1;

FIG. 3 shows a rear view of the lens receptacle carrier of FIG. 1;

FIG. 4 shows a front view of the lens receptacle carrier of FIG. 1, without lens receptacles arranged thereon and without sealing foils clamped thereto;

FIG. 5 shows a sectional view along the line V-V shown in FIG. 4;

FIG. 6 shows a semi-transparent top view of the lens receptacle carrier of FIG. 1, without lens receptacles and without sealing foils;

FIG. 7 shows a sectional view along the line VII-VII shown in FIG. 6;

FIG. 8 shows a perspective view of an embodiment of the system according the invention;

FIG. 9 shows a perspective view of the lens receptacle carrier of the embodiment of the system, an empty lens receptacle not yet arranged on the lens receptacle carrier, and a closed primary package;

FIG. 10 shows a perspective view of the lens receptacle carrier of FIG. 9, with the lens receptacle arranged on the lens receptacle carrier at the receptacle holder, and with the opened primary package containing one ophthalmic lens;

FIG. 11 shows a perspective view of the lens receptacle carrier of FIG. 10, with the sealing foil completely removed from the primary package and with the ophthalmic lens in the process of being transferred from the primary package to the lens receptacle arranged on the lens receptacle carrier;

FIG. 12 shows a perspective view of the lens receptacle carrier of FIG. 11, with the ophthalmic lens transferred to the lens receptacle, and with the sealing foil clamped by the associated foil holder;

FIG. 13 shows a perspective view of a strip of primary packages (before and after removal of the sealing foils);

FIG. 14 shows a perspective view of a lens receptacle carrier with an ophthalmic lens contained in four of the five lens receptacles arranged on the lens receptacle carrier.

### DETAILED DESCRIPTION OF EMBODIMENTS

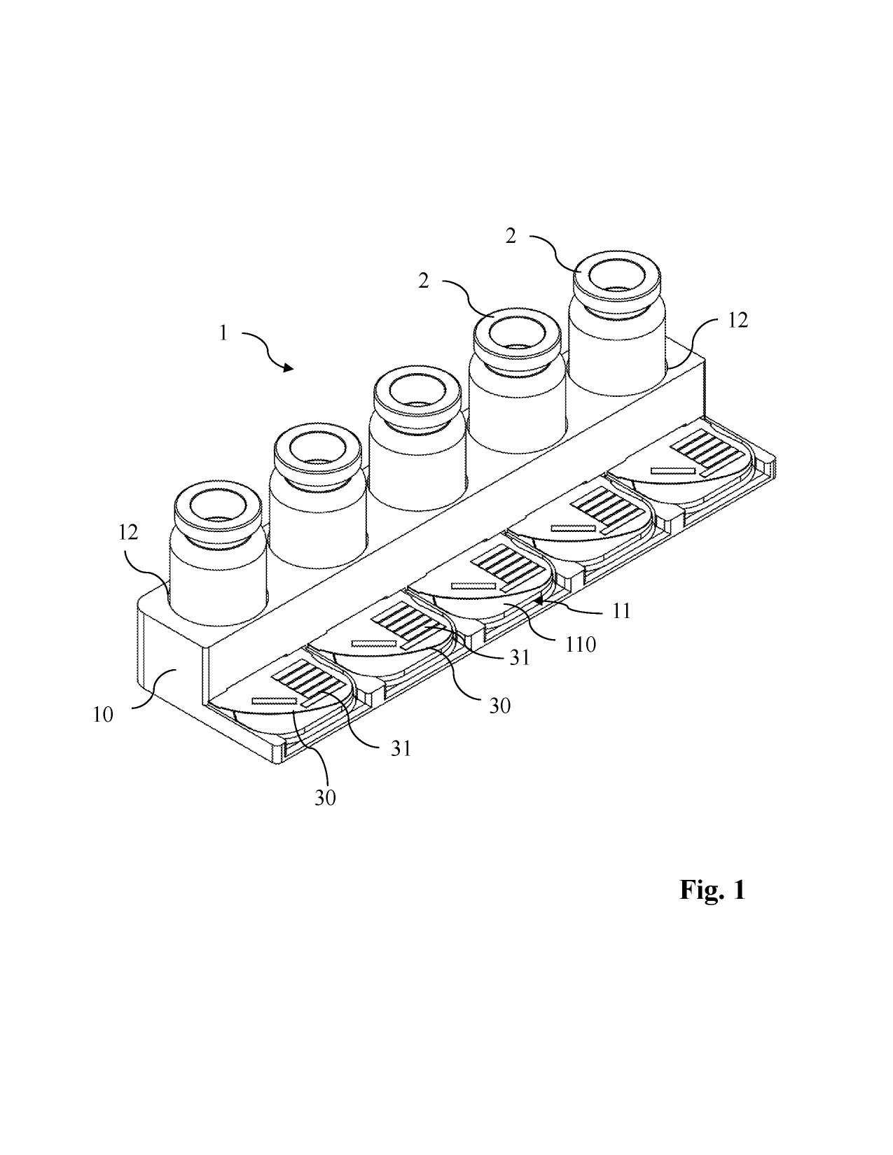

FIG. 1 shows a perspective view of a lens receptacle carrier 1. Lens receptacle carrier 1 comprises a holder block 10 comprising five receptacle holders 12, each receptacle holder 12 holding a lens receptacle 2. Each of the receptacle holders 12 is formed as a vertical cylindrical recess in the holder block 10 of lens receptacle carrier 1.

Lens receptacle carrier 1 further comprises five foil holders which are embodied as foil holder clips 11 mounted to holder block 10 of lens receptacle carrier 1. Each of the foil holder clips 11 is partly arranged underneath one of the receptacle holders 12. Each foil holder clip 10 holds a sealing foil 30 of a primary package (not shown in FIG. 1) from which an ophthalmic lens is transferred to a said lens receptacle 2 held by the respective receptacle holder 12. Foil holder clip 11 comprises a tray portion 110 for receiving and supporting sealing foil 30. Sealing foil 30 comprises a machine-readable unique lens identifier 31 applied thereto, e.g. by laser-printing. When the sealing foil 30 is arranged on the tray portion 110 of foil holder clip 11, the machine-readable unique lens identifier 31 is exposed for reading. In a database, the unique lens identifier 31 is allocated to manufacturing data of the ophthalmic lens supposed to be contained in the primary package that is sealed by the sealing foil 30 having the unique lens identifier 31 applied thereto. The location of each foil holder clip 11 is assigned to the receptacle holder 12 where it is partly arranged underneath.

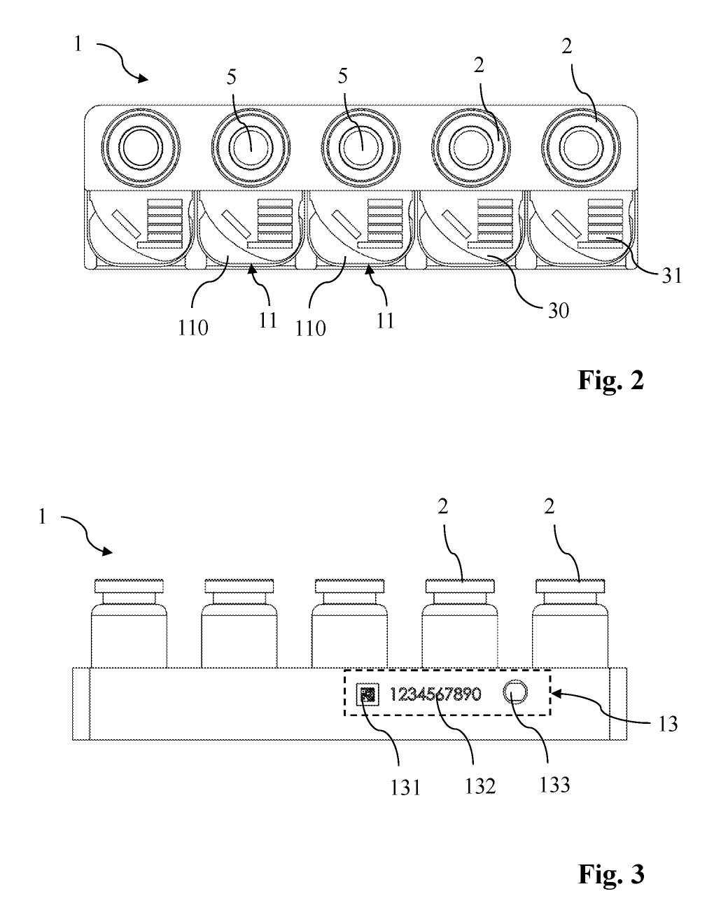

FIG. 2 shows a top view of lens receptacle carrier 1 with a said lens receptacle 2 arranged at each receptacle holder 12. As can be seen best in FIG. 2, the unique lens identifiers 31 applied to the sealing foils 30 are exposed for reading. An ophthalmic lens 5, in the embodiment a contact lens, is arranged in each lens receptacle 2.

In the embodiment shown, the unique lens identifier 31 may be embodied as or comprised by a machine-readable number. Alternatively, the unique lens identifier 31 may be embodied as or comprised by machine-readable text, a quick-response code (QR-code) or a bar code. The unique lens identifier 31 may be automatically read using a suitable reading device, such as an electronic reading device comprising a character recognition feature.

FIG. 3 shows a rear view of lens receptacle carrier 1 with lens receptacles 2 arranged at the receptacle holders 12. Lens receptacle carrier 1 comprises a unique carrier identifier 13 arranged at a rear face of the lens receptacle carrier 1. Unique carrier identifier 13 is exposed for reading and may be embodied as or comprised by a QR code 131 (i.e. a quick-response code), a machine-readable number 132 or a transponder 133 (typically only one of them, even though all of them are shown in FIG. 3 for illustrative purposes). In an alternative embodiment, unique carrier identifier 13 may be embodied as or comprised by a bar code (not shown in FIG. 3), or any other (preferably machine-readable) code.

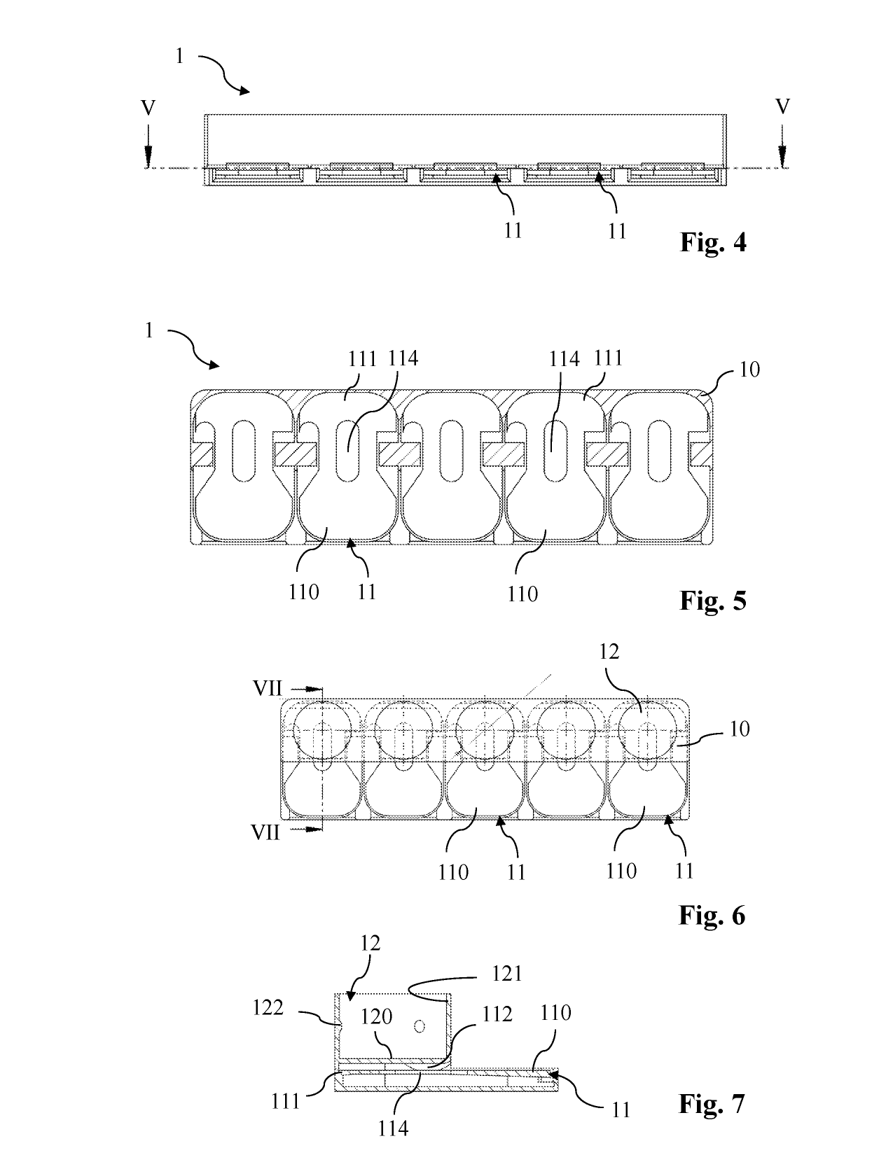

FIG. 4 shows a front view of lens receptacle carrier 1 and FIG. 5 shows a sectional top view of lens receptacle carrier 1 in a plane represented by line V-V in FIG. 4.

As can be seen in FIG. 5, each foil holder clip 11 comprises the tray portion 110 for supporting the bottom surface of the sealing foil 30 (not shown in FIG. 5, see FIG. 1), as well as a mounting portion 111 where foil holder clip 11 is mounted to holder block 10.

As can be seen in FIG. 6, a mounting portion 111 of foil holder clip 11 is arranged underneath holder block 10 and underneath a receptacle holder 12. Through this arrangement of tray portion 110 of foil holder clip 11 partially underneath a respective receptacle holder 12, the location of each foil holder clip 11 is spatially assigned to the respective receptacle holder 12. Tray portion 110 of foil holder clip 11 further comprises an elongate opening 114.

As can be seen in the sectional view of FIG. 7 (see line VII-VII in FIG. 6), tray portion 110 is flexibly mounted to holder block 10 via mounting portion 111 such that in the relaxed state a cam 112 slightly protrudes into elongate opening 114 of tray portion 110. A sealing foil 30 of a primary package 3 may be arranged at the respective foil holder clip 11 by pressing a front portion of tray portion 110 downwards, such that a gap opens between the tray portion 110 and cam 112. Introducing sealing foil 30 into the said gap and thereafter releasing the front portion of tray portion 110 again (allowing the front portion of tray portions 110 to return to its relaxed state) results in the sealing foil 30 being clamped between tray portion 110 and cam 112.

As can be seen further in FIG. 7, receptacle holder 12 is embodied as a cylindrical recess in holder block 10 and comprises a cylindrical receptacle holder inner side wall 121 as well as a receptacle holder bottom 120. Moreover, a plurality of receptacle holder protrusions 122 may be formed on the respective receptacle holder inner side wall 121 of receptacle holder 12. Thus, once a lens receptacle 2 is arranged at receptacle holder 12 it is held by friction at receptacle holder 12.

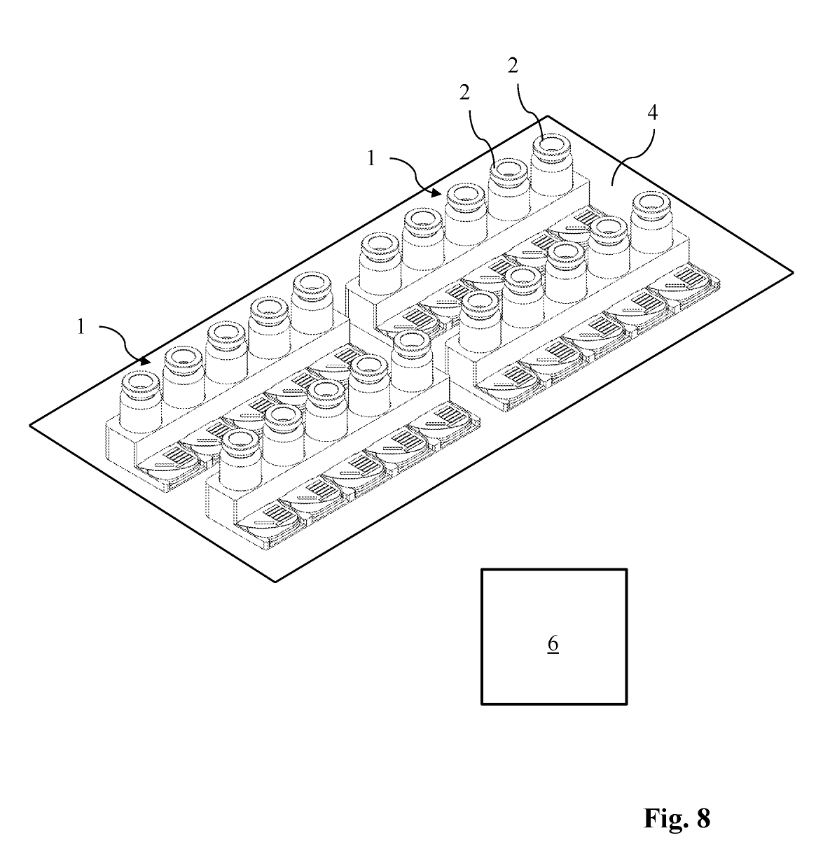

FIG. 8 shows an embodiment of a system for providing a predetermined number of (here: twenty) ophthalmic lenses, for example contact lenses, in a plurality of lens receptacles 2. The system comprises four lens receptacle carriers 1 of the type described above. The lens receptacle carriers 1 are arranged on a carrier tray 4 such that they can be commonly stored and transported to a location where a statistical process control may be performed (i.e. where the ophthalmic lenses contained in the receptacles 2 are inspected again and the inspection results are re-evaluated as to whether the ophthalmic lenses are compliant with the strict quality criteria).

The system further comprises a data storage 6. For each ophthalmic lens transferred from a said primary package 3 to a said respective lens receptacle 2, an assignment of the unique lens identifier 31 and the location of the corresponding receptacle holder 12 to the unique carrier identifier 13 of the respective lens receptacle carrier 1 is stored in data storage 6. As the manufacturing data for each ophthalmic lens are also stored in a database linked to the unique lens identifier 31, the manufacturing data for each ophthalmic lens are also known. These manufacturing data can be retrieved and examined for possible reasons in case an ophthalmic lens turns out not to be compliant with the strict quality criteria after inspection in the SPC.

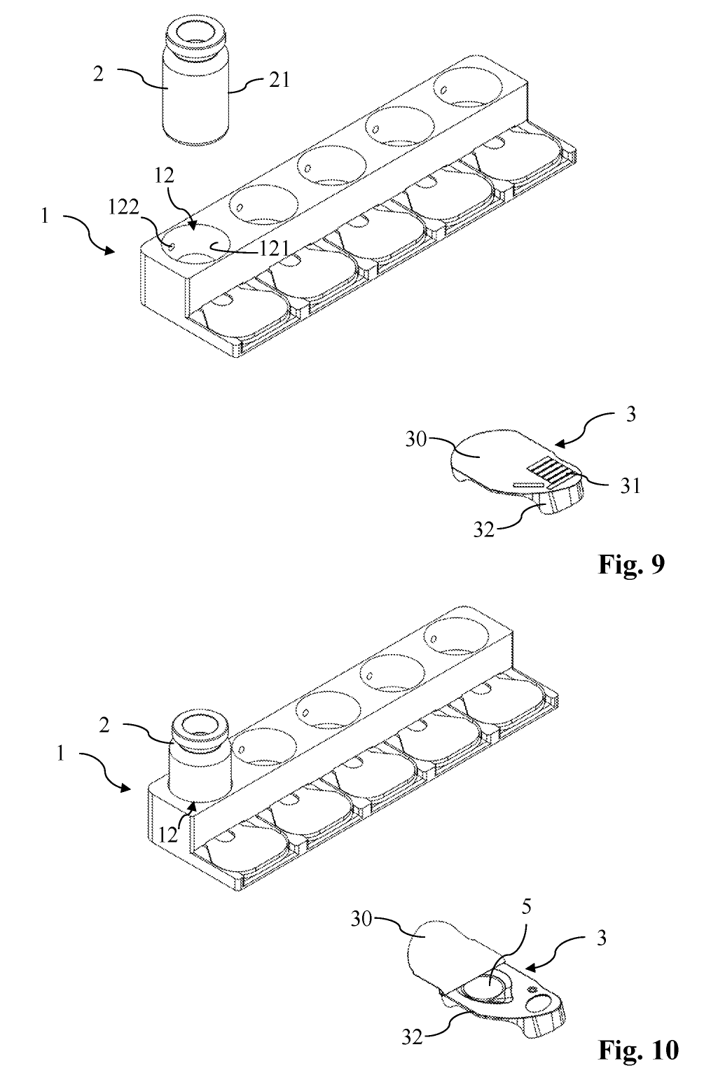

A method for providing a predetermined number of ophthalmic lenses 5 (in this embodiment contact lenses) in the lens receptacles 2 arranged on lens receptacle carrier 1 is now described with the aid of FIGS. 9 to 12.

FIG. 9 shows a closed primary package 3 with the sealing foil 30 sealed to the primary packaging shell 32 of primary package 3, and further shows the lens receptacle carrier 1 and one lens receptacle 2 to be arranged at a respective receptacle holder 12 of lens receptacle carrier 1. Primary package 3 is a primary package 3 from a first number of primary packages 3 drawn from a same lot of ophthalmic lenses produced on the manufacturing line. Each primary package 3 is supposed to contain one ophthalmic lens of that same lot. The unique lens identifier 31 allocated to the manufacturing data of the ophthalmic lens supposed to be contained in the said primary package 3 is preferably read prior to opening the primary package 3 by removing sealing foil 30 (through peeling). In addition, the unique carrier identifier 13 (see FIG. 3) of lens receptacle carrier 1 is read.

Lens receptacle 2 is arranged on lens receptacle carrier 1 at one of the receptacle holders 2. As has been explained above already, the cylindrical shape of the receptacle outer side wall 21 of lens receptacle 2 matches the shape of receptacle holder inner side wall 121 of receptacle holder 12. Lens receptacle 2 is held by friction at receptacle holder 12 by the receptacle holder protrusions 122 after lens receptacle 2 has been inserted.

In FIG. 10, lens receptacle 2 is shown inserted in and thereby arranged at receptacle holder 12. Primary package 3 is opened by (partially) removing sealing foil 30 from primary packaging shell 32, so that contact lens 5 may be accessed.

Next, the number of contact lenses actually contained in primary package 3 is determined. As can be seen in FIG. 10 (representing the normal scenario), primary package 3 contains exactly one ophthalmic lens 5 (here: one contact lens), so that primary package 3 qualifies as and is selected as a sample primary package (all sample primary packages must contain exactly one contact lens). In case the number of contact lenses contained in primary package 3 is different from one (e.g. two lenses are contained, or no lens is contained), primary package 3 does not qualify as a sample primary package and is rejected. Unique lens identifier 31 may nevertheless be read, however, a rejection flag may then be assigned to that unique lens identifier 31 and this assignment may be stored in the data storage 6 as well. However, in such instance no contact lens is transferred from the primary package 3 to a lens receptacle 2.

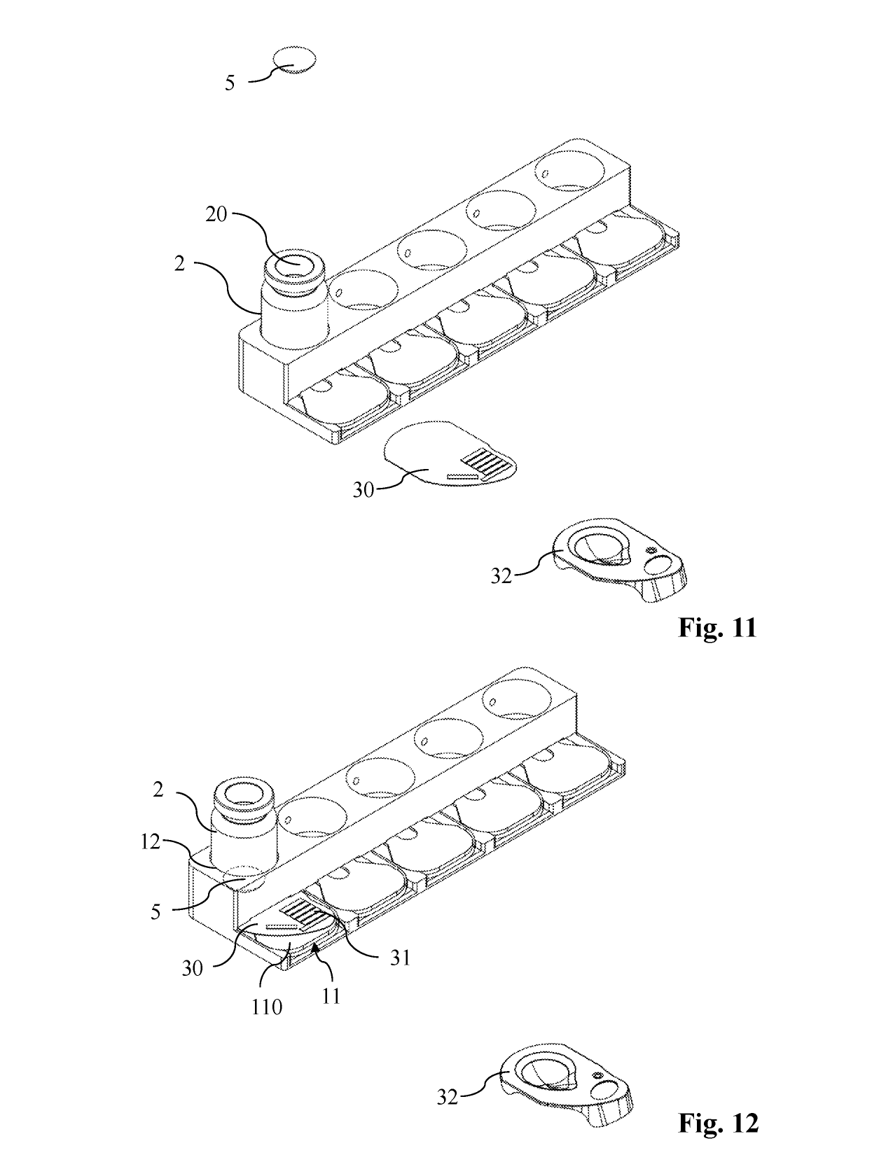

Returning to the normal scenario where exactly one contact lens 5 is contained in primary package 3, sealing foil 30 is entirely removed from the primary packaging shell 32 (see FIG. 11). Contact lens 5 is then removed from primary package shell 32, and is transferred to lens receptacle 2 for insertion through lens receptacle opening 20. The removal and transfer of contact lens 5 from primary packaging shell 32 to lens receptacle 2 may be performed either by an operator, i.e. manually, or by an automated gripper (not shown).

As is shown in FIG. 12, contact lens 5 is arranged in lens receptacle 2 which is filled with saline or water (not visible in the drawings). Sealing foil 30 is then arranged on tray portion 110 of foil holder clip 11 such that unique lens identifier 31 is exposed.

The unique lens identifier 31 and the location of the receptacle holder 12 on lens receptacle carrier 1 are assigned to the unique carrier identifier 13 – which has been read before – and the said assignment is then stored in data storage 6 (see FIG. 8).

The steps described with the aid of FIGS. 9 to 12 for one primary package 3 and one lens receptacle 2 are then repeated until a lens receptacle 2 with a contact lens 5 transferred from a respective sample primary package arranged therein is arranged at each of receptacle holder 12 of lens receptacle carrier 1. The afore-described steps are then repeated for each lens receptacle carrier 1 arranged on carrier tray 4.

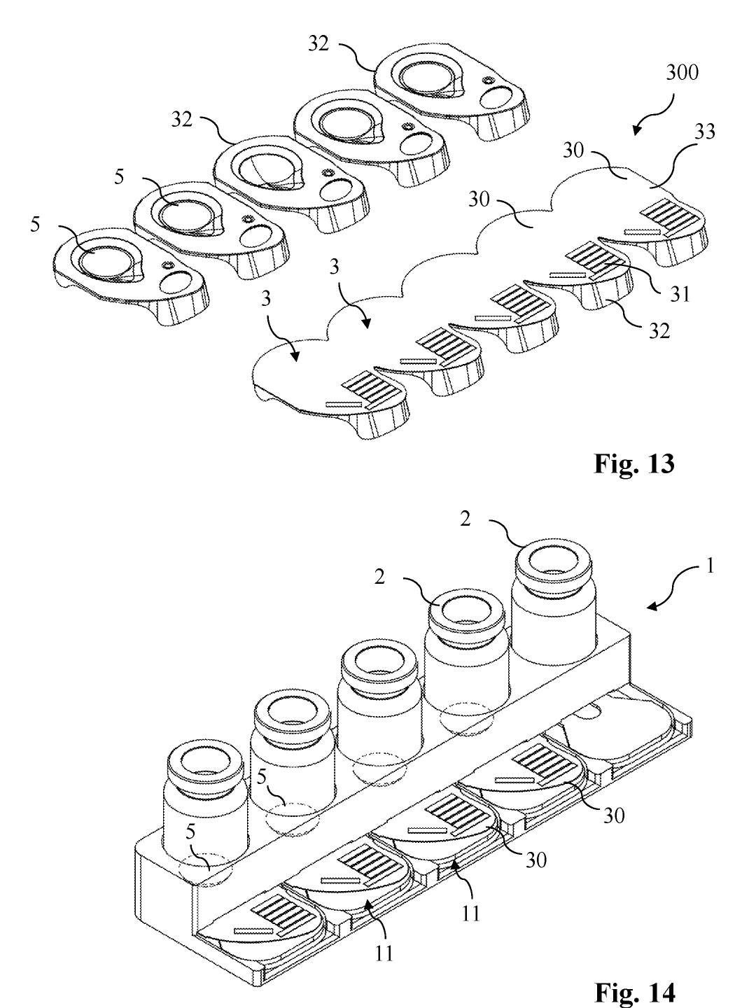

FIG. 13 shows a perspective view of a strip of primary packages before and after removal of the sealing foils 30. As can be seen, five primary packages 3 are separably connected to one another by a foil strip 33 (comprising the sealing foils 30 sealed to the primary packaging shells 32) to form a strip 300 of primary packages 3 prior to be being separated As can be seen, only four of the five primary packages 3 of the strip 300 contain exactly one contact lens 5. The centrally arranged primary package 3 contains no contact lens.

For each primary package 3 the steps described with the aid of FIGS. 9 to 12 are performed, preferably after the primary packages 3 forming the strip 300 have been separated. That primary package 3 containing no contact lens 5 is rejected. Sealing foil 30 sealing the primary package 3 containing no contact lens 5 is discarded. However, the unique lens identifier 31 applied to sealing foil 30 of the rejected primary package 3 may nevertheless be read before sealing foil 30 is discarded. As described, a rejection flag may be assigned to the read unique lens identifier 31 of the rejected primary package 3, and the said assignment may be stored in data storage 6.

The contact lenses 5 from those four primary packages 3 that qualify and are selected as sample primary packages 3 (sample primary packages must contain exactly one contact lens) are transferred to four different lens receptacles 2 which are arranged at four adjacently arranged receptacle holders 12 on lens receptacle carrier 1, as is shown in FIG. 14. The sealing foils 30 from those four primary packages 3 are arranged at the corresponding foil holder clips 11.

As a consequence, one lens receptacle 2 arranged on lens receptacle carrier 1 still does not contain a contact lens. Therefore, a contact lens 5 from a sample primary package 3 of another strip is transferred to that receptacle 2, so that finally each of the lens receptacles 2 arranged at the receptacle holders 12 of lens receptacle carrier 1 contains one contact lens 5. The sealing foil 30 from that primary package 3 from said other strip is arranged at the remaining foil holder clip 11. After completion, each of the lens receptacles 2 arranged at the receptacle holders 12 of lens receptacle carrier 1 contains one contact lens 5, and the corresponding sealing foil 30 is arranged at the respective foil holder clip 11 as is shown in FIG. 1 (the contact lenses not being visible in FIG. 1).

The steps described above are then performed for each of the four lens receptacle carriers 1 of the system shown in FIG. 8, whereupon carrier tray 4 is complete.

Carrier tray 4 with the four carriers arranged thereon may subsequently be transported to a location where the Statistical Process Control (SPC) is performed. In the SPC, a double-check may be performed whether the stored assignment of the unique lens identifier 31 of each transferred contact lens 5 and the receptacle location (i.e. the location of the respective receptacle holder 12 on lens receptacle carrier 1) to the respective unique carrier identifier 13 matches with the unique lens identifier 31 present on the sealing foil 30 arranged at the respective foil holder clip 11 of lens receptacle carrier 1. For that purpose, the respective unique carrier identifier 13 of each of the four lens receptacle carriers 1 is re-read, and the unique lens identifiers 31 present on the sealing foils 30 arranged at the foil holder clips 11 are re-read as well and are compared as to whether each unique lens identifier 31 re-read from the sealing foil 30 arranged at the foil holder clip 11 of the lens receptacle carrier 1 match with the unique lens identifier 31 and the location of the receptacle holder 2 retrieved from the unique carrier identifier 13.

Embodiments of the method and the system according to the present invention have been described with the aid of the drawings. However, the invention is not limited to these embodiments. Rather, various changes and modifications can be made without departing from the teaching underlying the instant invention. The scope of protection is therefore defined by the appended claims.

1. Method for providing a predetermined number of ophthalmic lenses (5), in particular contact lenses such as soft contact lenses, manufactured in an automated lens manufacturing process in a plurality of lens receptacles (2) arranged on one or more lens receptacle carriers (1), the method comprising the steps of:
drawing a first number of primary packages (3), each supposed to contain one ophthalmic lens (5) of a same lot of ophthalmic lenses manufactured in the automated lens manufacturing process, and each comprising a machine-readable unique lens identifier (31) allocated to manufacturing data of the ophthalmic lens (5) supposed to be contained therein,
selecting from the first number of primary packages (3) a second number of primary packages (3) as sample primary packages (3), each sample primary package (3) actually containing one ophthalmic lens (5), the second number of primary packages (3) corresponding to the predetermined number of ophthalmic lenses (5) to be provided,
reading the machine-readable unique lens identifier (31) of each sample primary package (3),
reading a machine-readable unique carrier identifier (13) of each of the one or more lens receptacle carriers (1),
transferring each ophthalmic lens (5) from the respective sample primary package (3) to a different lens receptacle (2) of the plurality of lens receptacles (2) arranged at a respective receptacle location on the one or more lens receptacle carriers (1), and
for each transferred ophthalmic lens (5), assigning the unique lens identifier (31) and the receptacle location on the lens receptacle carrier (1) to the unique carrier identifier (13) of the one or more lens receptacle carriers (1), and storing said assignment.

2. Method according to claim 1,
wherein each primary package (3) is sealed by a sealing foil (30), and
wherein the machine-readable unique lens identifier (31) allocated to the manufacturing data for the ophthalmic lens (5) supposed to be contained therein is applied to the sealing foil (31),
the method further comprising the steps of
removing the sealing foil (30) from each primary package (3), and
arranging the sealing foil (30) of each sample primary package (3) on the lens receptacle carrier (1) at a location that is assigned to the respective different lens receptacle (2) to which the respective ophthalmic lens (5) has been transferred, with the respective machine-readable unique lens identifier (31) being exposed for reading.

3. Method according to claim 2, wherein subsequent to the step of arranging the sealing foil (30) of each sample primary package on the lens receptacle carrier (1) the method further comprises the steps of:
re-reading the unique carrier identifier (13) of each of the one or more lens receptacle carriers (1),
re-reading the unique lens identifier (31) of each sealing foil (30) arranged on the lens receptacle carrier (1) at the respective location that is assigned to the respective different lens receptacle (2),
retrieving for each unique carrier identifier (13) the stored assignment of the unique lens identifiers (31) and the receptacle locations to the said unique carrier identifier (13),
for each lens receptacle carrier (1) and its unique carrier identifier (13) determining whether the re-read unique lens identifiers (31) and the locations at which the sealing foils (30) are arranged on the respective lens receptacle carrier (1)
match with
the unique lens identifiers (31) and the receptacle locations on the respective lens receptacle carrier (1) of the stored assignment.

4. Method according to claim 1,
wherein the step of selecting from the first number of primary packages (3) a second number of primary packages (3) as sample primary packages (3) further comprises
successively opening the primary packages (3) of the first number of primary packages (3) and
determining the number of ophthalmic lenses (5) contained in each primary package (3),
and thereafter
selecting the respective primary package (3) as sample primary package (3) in case the determined number of lenses (5) contained in the respective primary package (3) is one,
rejecting the respective primary package (3) in case the determined number of ophthalmic lenses (5) contained in the respective primary package (3) is different from one,
wherein the step of reading the machine-readable unique lens identifier (31) of each sample primary package (3) comprises reading the machine-readable unique lens identifier (31) of all primary packages (3) of the first number of primary packages (3), and
in case at least one primary package (3) of the first number of primary packages (3) is rejected, assigning a rejection flag to the unique lens identifier (31) of each rejected primary package (3), and storing said assignment.

5. Method according to claim 1,
wherein the primary packages (3) are separably connected to one another to form strips (300) of primary packages, each strip (300) comprising a predetermined number of primary packages (3),
wherein each lens receptacle carrier (1) of the one or more lens receptacle carriers (1) comprises a predetermined number of lens receptacles (2) arranged thereon corresponding to the predetermined number of primary packages (3) of a said strip (300), and
wherein the step of drawing the first number of primary packages (3) comprises drawing a number of strips of primary packages (3) larger than the number of lens receptacle carriers (1),
and wherein
in case each primary package (3) of a said strip (300) of primary packages (3) is a sample primary package (3) containing one ophthalmic lens (5), transferring the ophthalmic lens from the respective sample primary package (3) into the respective different one of the lens receptacles (2) arranged on a said lens receptacle carrier (1) of the one or more lens receptacle carriers (1),
in case a primary package (3) of a said strip (300) of primary packages (3) contains a number of ophthalmic lenses (5) different from one, transferring only those ophthalmic lenses (5) from the sample primary packages (3) of the said strip (300) to the respective different ones of the lens receptacles (2) of a said lens receptacle carrier (1) of the one or more lens receptacle carriers (1), and transferring an ophthalmic lens (5) from a sample primary package (3) of another said strip of the drawn number of strips (300) to the remaining lens receptacle (2) of the said lens receptacle carrier (1) of the one or more lens receptacle carriers (1), such that each lens receptacle (2) of the said lens receptacle carrier (1) of the one or more lens receptacle carriers (1) contains one ophthalmic lens (2).

6. Method according to claim 5, wherein the predetermined number of primary packages (3) separably connected to one another to form a strip (300) of primary packages (3) is five, and the number of lens receptacle carriers (1) is four.

7. Method according to claim 1, wherein the predetermined number of ophthalmic lenses (5) is twenty.

8. Method according to claim 1, wherein the step of reading the machine-readable unique lens identifier (31) comprises reading at least one selected from the group of a machine-readable text, a quick-response code (QR-code), a machine-readable number, and a bar code, comprising the unique lens-identifier (31).

9. A system for providing a predetermined number of ophthalmic lenses (5), in particular contact lenses such as soft contact lenses (5), in a plurality of lens receptacles (2), one ophthalmic lens (5) in each lens receptacle (2) of the plurality of lens receptacles (2), each ophthalmic lens (2) being manufactured in a same lot in an automated lens manufacturing process and being transferred from a primary package (3) containing the ophthalmic lens (5), the primary package (3) comprising a machine-readable unique lens identifier (31) allocated to manufacturing data for the ophthalmic lens (5) contained therein,
the system comprising:
one or more said lens receptacle carriers (1), each comprising
a machine-readable unique carrier identifier (13), and
a plurality of receptacle holders (12), each receptacle holder (12) being configured to hold one said lens receptacle (2), and being located at a different holder location on the one or more lens receptacle carriers (1),
and
a data storage (6) configured for storing an assignment of the unique lens identifier (31) and the receptacle holder location on the lens receptacle carrier (1) to the unique carrier identifier (31) of the one or more lens receptacle carriers (1).

10. The system according to claim 9,
wherein each primary package (3) is sealed by a sealing foil (30), wherein the machine-readable unique lens identifier (31) allocated to the manufacturing data for the ophthalmic lens (5) contained therein is applied to the sealing foil (30),
and wherein each lens receptacle carrier (1) comprises a number of foil holders corresponding to the number of receptacle holders (12), each for holding the sealing foil (30) of one primary package (3),
wherein each foil holder is arranged at a location assigned to the respective receptacle holder (12).

11. The system according to claim 10,
wherein each of the foil holders comprises a foil holder clip (11) partly arranged underneath the respective receptacle holder (12),
the foil holder clip (11) comprising a tray portion (110) for receiving the respective sealing foil (30) to be arranged thereon such that the respective machine-readable unique lens identifier (31) is exposed for reading.

12. The system according to claim 9,
wherein the primary packages (3) are separably connected to form strips (300) of primary packages (3), each strip (300) formed by a predetermined number of primary packages (3),
wherein the number of receptacle holders (12) of each of the one or more lens receptacle carriers corresponds to the number of primary packages (3) of the respective strip (300) of primary packages (3).

13. The system according to claim 12,
wherein a said strip (300) of primary packages (3) is formed by five primary packages (3), and wherein each lens receptacle carrier (1) comprises five receptacle holders (12) and wherein the one or more lens receptacle carriers (1) contain four lens receptacle carriers (1).

14. The system according to claim 9, wherein the machine-readable unique carrier identifier (13) is comprised by at least one selected from the group of a quick-response code (QR-code) (131), a machine-readable text, a machine-readable number (132), a transponder (133), and a barcode.
